(19) United States
(12) Patent Application Publication
(10) Pub. No.: US 2009/0305760 A1
(43) Pub. Date: Dec. 10, 2009

(54) Portable electronic game machine

(75) Inventor: Akiko Shimizu, Tokyo (JP)

Correspondence Address: STAAS & HALSEY LLP, SUITE 700, 1201 NEW YORK AVENUE, N.W., WASHINGTON, DC, 20005, US

(73) Assignee: TOMY COMPANY, LTD, Tokyo (JP)

(21) Appl. No.: 12/457,057

(22) Filed: May 29, 2009

(30) Foreign Application Priority Data
Jun. 6, 2008 (JP) 2008-149023

(51) Int. Cl. A63F 9/24; A63F 13/00

(52) U.S. Cl. 463/9; 463/30

(57) ABSTRACT

Disclosed is a portable electronic game machine comprising: a chassis which can be in a basic configuration where each of a front plane, left plane, right plane, flat plane, bottom plane and rear plane is composed of a same number of blocks in vertical and horizontal directions and the chassis can change its configuration by rotating the block around three axis lines, wherein each block group provided aligned along each of the three axis lines is structured to be able to rotate around the axis line independently with respect to other block groups; part of the blocks is a game machine block; part of the remaining blocks is an information holding block to hold identification information; the game machine block includes an identification information detecting section; and the game section is structured to advance the game by reflecting a detected result by the identification information detecting section.

### BACKGROUND OF THE INVENTION

1. Field of the Invention

The present invention relates to a portable electronic game machine.

2. Description of Related Art

Conventionally, it has been typical that a portable electronic game machine to perform a game on a display is provided with an operation button and the game advances while operating the operation button. Also, on the other hand, there is known a portable game machine without a display which is played by changing a configuration of a chassis (for example, Japanese Utility Model Registration No. 3050942 (FIG. 1)).

In the first portable electronic game machine described above, the game can be enjoyed only on the display. Also, the second portable game machine described above cannot be played using a display.

### SUMMARY OF THE INVENTION

The present invention has been made in consideration of the above situation, and it is one of main objects to provide a portable electronic game machine which can be played by changing a configuration of the game machine itself as well as playing the game on a display.

According to an aspect of the present invention, there is provided a portable electronic game machine including:

a chassis which can be in a basic configuration where each of a front plane, left plane, right plane, flat plane, bottom plane and rear plane is composed of a same number of blocks in vertical and horizontal directions and the chassis can change its configuration by rotating the block around three axis lines which are orthogonal to each other and which pass through the center of the plane, wherein

each block group provided aligned along each of the three axis lines is structured to be able to rotate around the axis line independently with respect to other block groups;

part of the blocks is structured as a game machine block;

at least part of the remaining blocks is structured as an information holding block to hold identification information;

the game machine block includes:
a game section to advance a game;
a display section to display an image of a game advanced by the game section; and
an identification information detecting section which can detect the identification information when the information holding block and the game machine block are in a predetermined position relation; and

the game section is structured to advance the game by reflecting a detected result by the identification information detecting section.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, and wherein:

FIG. 1 is a perspective view showing a portable electronic game machine of a preferred embodiment;

FIG. 2 is a perspective view showing a game machine block of the portable electronic game machine shown in FIG. 1;

FIG. 3 is a front elevation view showing an example of a joint member of the portable electronic game machine shown in FIG. 1;

FIG. 4 is a perspective view showing an example of a freely moving member of the portable electronic game machine shown in FIG. 1;

FIG. 5 is a diagram showing an example of assembling a block to the joint member of the portable electronic game machine shown in FIG. 1;

FIGS. 6A and 6B are diagrams showing a detecting structure of a face of the portable electronic game machine shown in FIG. 1;

FIG. 7 is a block diagram showing a circuit system of the portable electronic game machine shown in FIG. 1; and

FIG. 8 is a diagram showing an example of a design displayed on a design block of the portable electronic game machine shown in FIG. 1.

### DESCRIPTION OF THE PREFERRED EMBODIMENTS

A portable electronic game machine of an embodiment of the present invention will be described below with reference to the drawings.

Here, “to advance the game by reflecting a detected result” means, for example, the detected result is a starting condition of the game, the detected result is a selecting condition of the game content, the detected result is used as a condition of overcoming a problem in a game where a problem is given, the detected result is used as an answer in a game where a quiz is given, in a game where an event occurs, the detected result is a condition of the event occurring or overcoming the event, etc.

Here, an example of a specific embodiment of a “chassis”, the chassis is structured with an exterior appearance with eight blocks and it is structured in a configuration where one block group is composed of four blocks arranged around a predetermined axis line on a front plane, left plane, right plane, flat plane, bottom plane and rear plane when the exterior appearance is in the basic configuration. The four blocks are structured so that the four blocks can rotate relatively to other blocks independently around the predetermined axis line. This specific embodiment can be applied where the block group is (X raised to the second power) blocks (X is an even number 4 or more). In this case, the block group is in a configuration where other blocks surround the four blocks.

Also, an example of a specific embodiment of a “chassis”, the chassis, is structured with an exterior appearance with twenty-six blocks and it is structured in a configuration where one block group is composed of one block on a predetermined axis line and eight blocks aligned around the block on a front plane, left plane, right plane, flat plane, bottom plane and rear plane when the exterior appearance is in the basic configuration. The block group is structured so that the blocks can rotate relatively to other blocks independently around the predetermined axis line. At least one of the blocks is structured as the game machine block. This specific embodiment can be applied to (X raised to the second power) blocks (X is an odd number 5 or more). In this case, the block group is in a configuration where other blocks surround the nine blocks.

Here, “design” is used to include all of the following, character, figure, symbol, color, pattern, or any combination of the above.

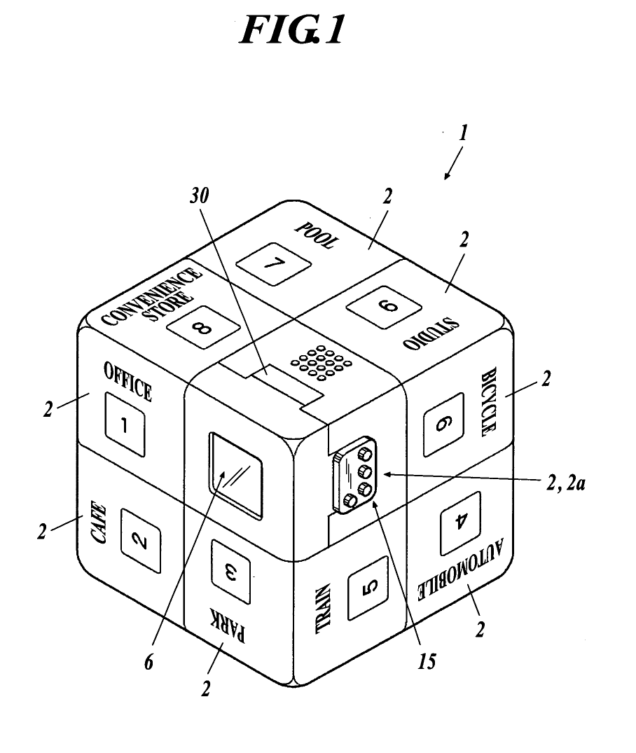

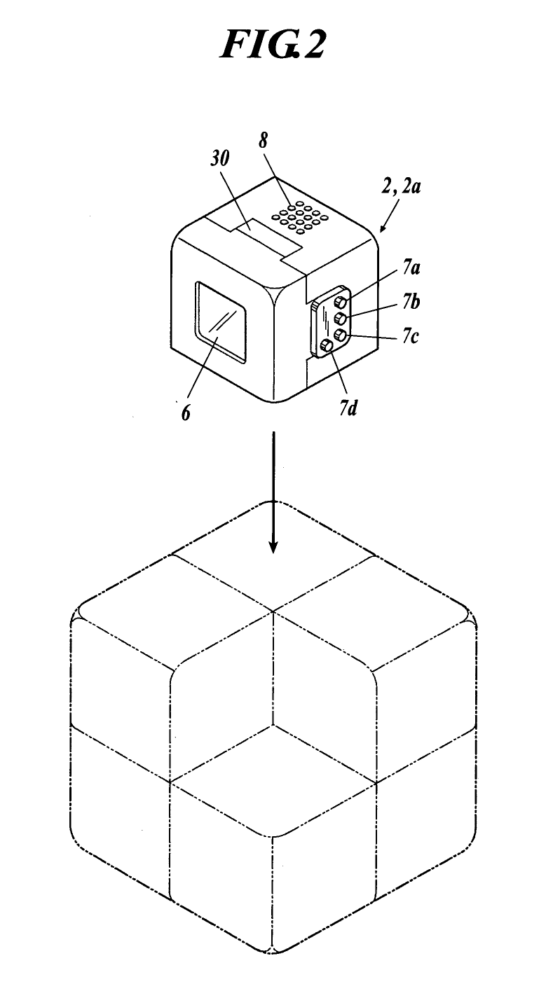

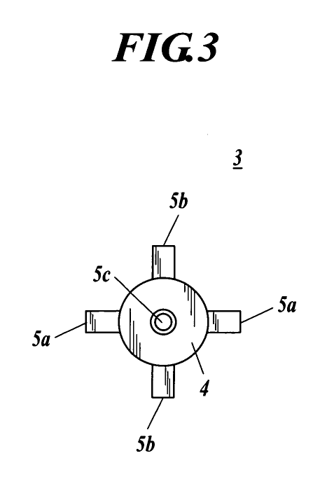

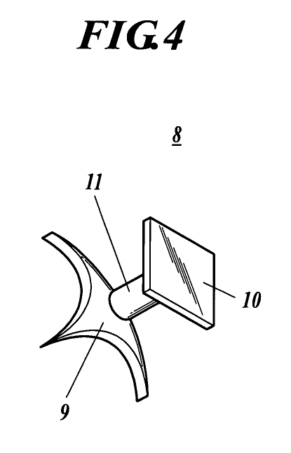

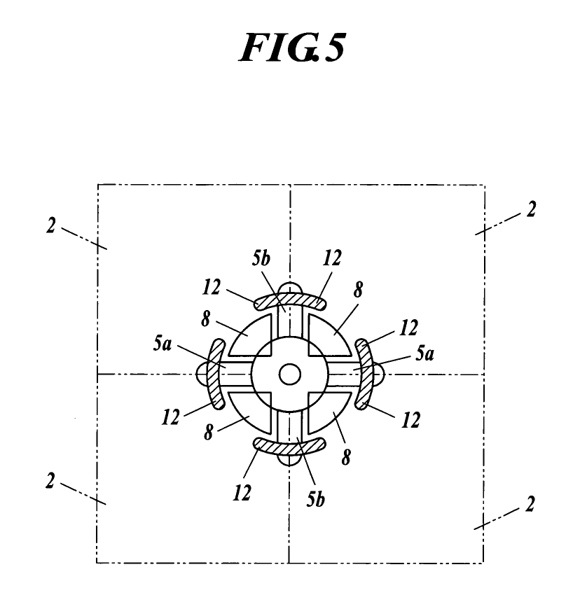

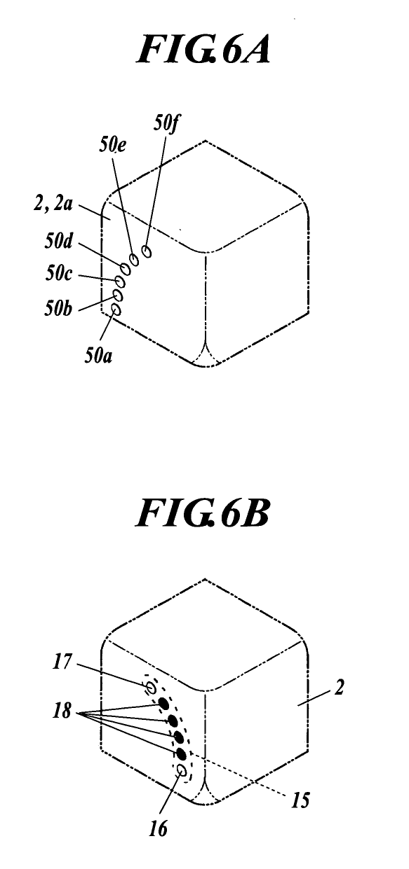

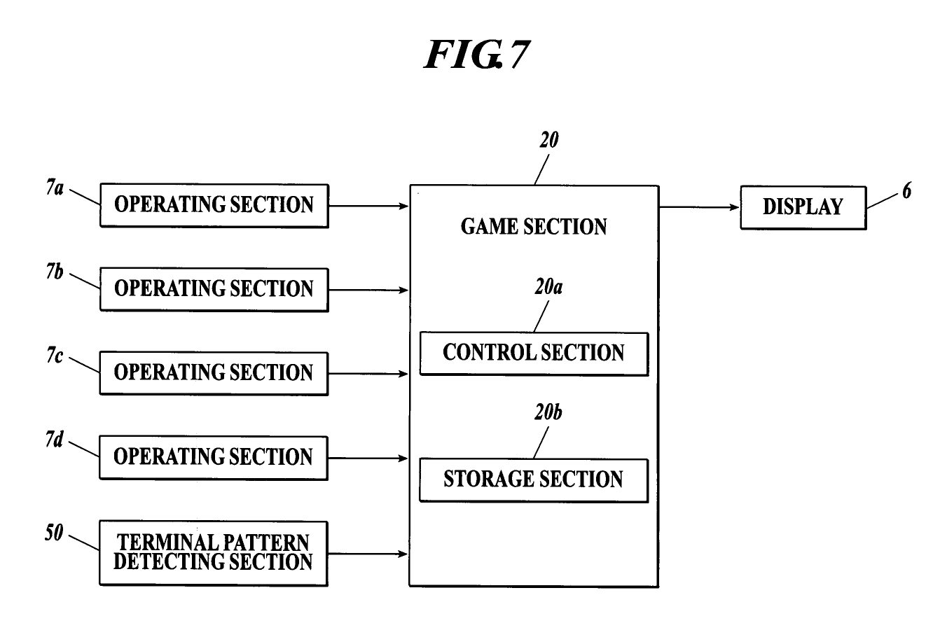

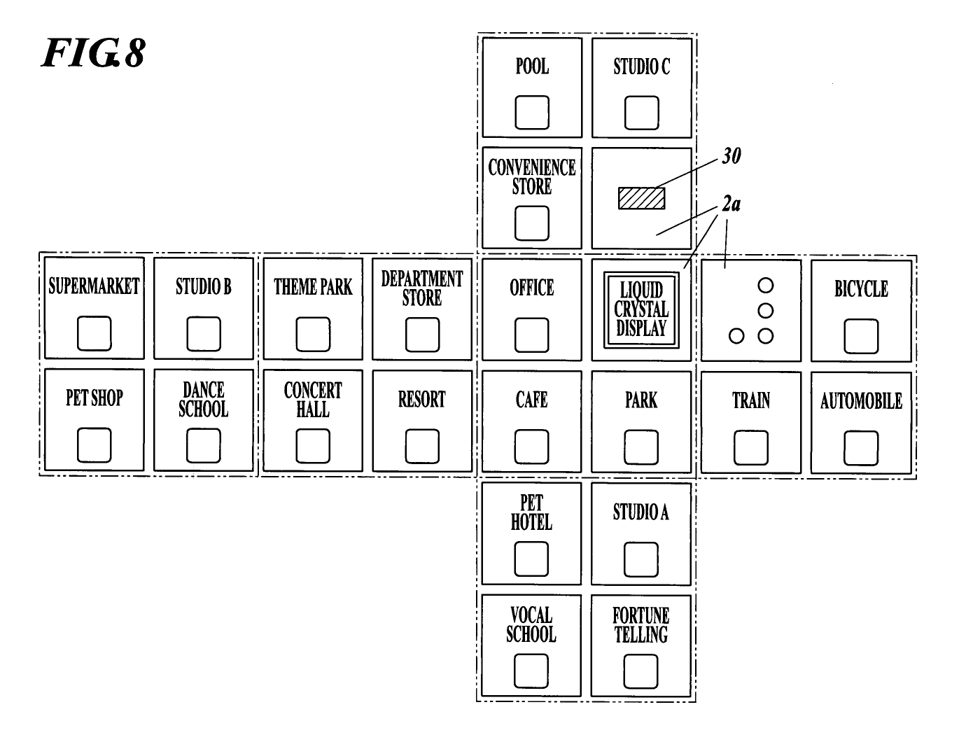

FIG. 1 is a perspective view showing a portable electronic game machine, FIG. 2 is a perspective view showing a game machine block, FIG. 3 is a front elevation view showing a joint member, FIG. 4 is a perspective view showing a rotating member, FIG. 5 is a diagram showing an example of assembling a block to the joint member, FIG. 6A and FIG. 6B are each a block showing a detecting structure of a face, FIG. 7 is a block diagram showing a circuit system, and FIG. 8 is a diagram showing an example of a design displayed on a block.

### (Overall Structure)

A basic configuration of a portable electronic game machine 1 of an embodiment of the present invention is not limited, and is structured in an overall cube shape. The portable electronic game machine 1 includes eight blocks 2 and joint member 3 (see FIG. 3). Also, as for the portable electronic game machine 1, eight blocks 2 are connected through joint member 3 and two blocks 2 are in a configuration aligned in a vertical direction, horizontal direction and depth direction.

In other words, as for the portable electronic game machine 1, an exterior appearance is structured by eight blocks 2 and it is structured in a configuration where one block group is composed of four blocks arranged around a predetermined axis line on a front plane, left plane, right plane, flat plane, bottom plane and rear plane when the exterior appearance of the portable electronic game machine 1 is in the basic configuration. Also, every four blocks are structured so that the four blocks can rotate relatively to other blocks independently around the predetermined axis line.

Also, in the portable electronic game machine 1, one of the blocks 2 among the eight blocks 2 is a game machine block 2a. The game machine block 2a is designed so that a game can be played on a display (display section) 6 provided on one of an outer face. Also, on the game machine block 2a, the game advances by reflecting a design of a face to the left of the display 6 shown in FIG. 1.

Below, joint member 3, block 2, connecting structure of block 2, face detection mechanism of block 2, circuit system of game machine block 2a, marked content of block 2 and game performed by the game machine block 2a will be described in this order.

### (Joint Member 3)

To explain an example of a joint member 3, the joint member 3 includes three axis lines orthogonal to each other. In other words, as shown in FIG. 3, the joint member 3 is fixed with six axes 5a, 5b, 5c to have three axis lines in the spherical center portion 4. A same reference numeral is applied to the section composing the same axis line shown in FIG. 3. Incidentally, for convenience of making the figure, one of the axes 5c positioned in the rear side of the figure is omitted.

Incidentally, as the joint member, there are various members known, such as Japanese Utility Model Registration No. 3050942, Japanese Unexamined Patent Application Publication No. 2007-509640, Japanese Utility Model Application Laid-Open Publication No. S62-113593.

### (Block 2)

The three outer faces adjacent to each other in block 2 are substantially the same size and substantially square. As described above, one of the blocks among the eight blocks 2 is a game machine block 2a. A first outer face of the game machine block 2a is provided with a display 6 as a display section as shown in FIG. 1 and FIG. 2. The display 6 is for displaying a content of a game. Also, a second outer face of the game machine block 2a is provided with game operating section 7a, 7b, 7c, 7d. Further, a third outer face of the game machine block 2a is provided with a sound outputting hole 8. Incidentally, reference numeral 30 shows an infrared communication device which communicates with other portable electronic game machines, etc. Also, the game machine block 2a includes a sound generating device (not shown) which, for example, generates an electronic sound each time the game operating section 7a to 7d is operated, instructs the game player by sound during the process of performing the game advancing program, plays music when the game ends, etc.

### (Connecting Structure of Block 2)

To explain an example of a connecting structure of the block 2, the connecting of the block 2 is performed through eight block supporting members 8 shown in FIG. 4. The block supporting member 8 is composed of a rubbing contacting plate 9 on a base end side, a block attaching section 10 on the tip end side and a connecting section 11 in between, in an integrated manner. Among these, an inner face of the rubbing contacting plate 9, although not limited, has the same curvature as an outer face of the spherical center portion 4 of the joint member 3. The shape of the block attaching section 10 can be freely chosen.

As shown in FIG. 5, the block supporting member 8 is placed so that the inner face of the rubbing contacting plate 9 is in contact with the outer face of the center portion 4 of the joint member 3. In this state, each tip of the six axes 5a, 5b, 5c of the joint member 3 are threadably mounted with retaining piece 12. The retaining piece 12 holds the block supporting member 8 between the retaining piece 12 and the center portion 4 and has a function to prevent the block supporting section 8 from falling off from the joint member 3. Incidentally, for convenience of making the figure, the block attaching section 10 and the connecting section 11 of the joint member 8 is omitted in the figure.

In this way, the eight block supporting members 8 are combined to the joint member 3. In this state, a gap between the adjacent retaining pieces 12 is formed in a size to allow the connecting section 11 to move when the block supporting member 8 rotates around the axes 5a, 5b, 5c of the block supporting member 8. As a result, the block supporting member 8 can rotate around the three axis lines.

Then, one block 2 is attached to each block attaching section 10 of each block supporting member 8. In this case, the block 2 can be attached by a thread or can be fitted tightly. Also, the block 2 can be attached by using a dovetail groove, etc. The block 2 can be fixed to the block attaching section 10 with adhesive material, however it is preferable that only the game machine block 2a is detachable. This is for repair and replacement of the game machine block 2a.

Incidentally, in the above described connecting structure, all of the eight blocks 2 which are separate bodies from the joint member 3 are connected to the joint member 3, however, one of the blocks among the eight blocks 2 can be integrated with the joint member 3. As an example of the integrated sections, there is known a technique described in Japanese Utility Model Registration No. 3050942.

### (Mechanism of Face of Block 2)

As shown in FIG. 6A, six electric terminals 50a, 50b, 50c, 50d, 50e, 50f are provided on one (left side face when the display 6 is the front face) of the three inner faces of the game machine block 2a. Among these, the electric terminal 50a is a common terminal (power feeding terminal) and the remaining electric terminals are detecting terminals. On the other hand, a conductive pattern 15 is formed on the inside of each of the other blocks 2 with the same shape and length. Each face of the other blocks 2 (hereinafter referred to as “design block 2” to distinguish from the “game machine block 2a”) are provided with six terminals at a position to be respectively in contact with the six electric terminals 50a, 50b, 50c, 50d, 50e, 50f. An example of the six terminals is shown in FIG. 6B. Among the six terminals, the terminal which corresponds to the electric terminal (power feeding terminal) 50a is a power receiving terminal (electric terminal) 16, and is to be electrically connected to the conductive pattern 15 when the block 2 is suitably rotated. The power receiving terminal 16 is provided on all of the inner faces of all of the design blocks 2. The rest of the five terminals are a combination of an electric terminal 17 and a dummy terminal 18. The electric terminal 17 is electrically connected to the conductive pattern 15 and the dummy terminal 18 is a nonconductive terminal. In FIG. 6B, the electric terminal 17 is shown in a white circle and the dummy terminal 18 is shown in a black circle. The combination (terminal pattern) of the electric terminal 17 and the dummy terminal 18 excluding the power receiving terminal 16 is different in all of the inner faces of the design block 2.

According to the detecting structure structured as described above, the design block 2 is fed with predetermined power from the electric terminal 50a of the game machine block 2a through the power receiving terminal 16, and thereby the terminal pattern on the design block 2 side can be detected through the detecting terminal of the game machine block 2a. The terminal pattern is the identification information recited in the claims, and when the terminal pattern detecting section which is the identification information detecting section detects the terminal pattern, the design which is adjacent to the game machine block 2a and which is aligned on the same plane as the face of the display 6 can be indirectly read.

Incidentally, a Radio Frequency Identification (RFID) tag can be provided near each of the inner faces of the design block 2 to detect the identification information of the design block 2 by reading the tag. Needless to say, other methods may also be used.

(Circuit System of Game Machine Block 2a)

The game section 20 included in the game machine block 2a includes a control section 20a and a storage section 20b. The storage section 20b stores various game advancing programs, etc. The control section 20a performs various game advancing programs, etc. stored in the storage section 20b as well as perform display control of the display 6 and function control of the operating sections 7a to 7d. Also, the control section 20a receives a detecting signal from the terminal pattern detecting section 50 including the six electric terminals 50a, 50b, 50c, 50d, 50e, 50f according to the various game advancing programs, etc. stored in the storage section 20b and performs the game procedure.

### (Marked Content of the Block 2)

FIG. 8 is an expanded view showing the outer faces (exposed faces) of the eight blocks 2 of the portable electronic game machine 1. Buildings, facilities, vehicles, etc. are marked with characters on the outer faces of the design blocks 2. Also, numbers are marked on the outer faces of the design blocks 2. Here, although not limited, it is preferable that all of the outer faces of the design block 2 have different marks. Characters and numbers are used here, however, needless to say, colors, patterns, or pictures can be used.

### (Game Example)

When the power is turned on with for example, the game operating section 7d, the type of game is displayed on the display 6. Then, with for example, the game operating section 7b, one of the games is selected and by operating, for example, the game operating section 7c, the game is determined.

### 1. Memory Game

When the memory game is selected, numbers are displayed in order on the display 6. For example, first two numbers, for example, “2” and “14” are displayed. The game player memorizes the numbers and rotates the block 2 to first move the face of the design block 2 (face marked with the number “2”) to the left of the display 6 of the game machine block 2a and presses, for example, the game operating section 7c. Next, the game player moves the face of the design block 2 (face marked with the number “14”) to the left of the display 6 of the game machine block 2a and presses, for example, the game operating section 7c. When the game player is correct, the next question is given. As the game player continues to give the correct answer, the number of numbers to be memorized increases. The game is over when the game player makes a mistake when answering.

### 2. Character Collecting Game.

When the block 2 is rotated and a face of the design block 2 is moved to the left of the display 6 of the game machine block 2a and for example, the game operating section 7c is pressed, it is assumed the place marked on the face is visited. Various characters can be collected according to the order of the places visited. On the way, a hint to collect a certain character is displayed on the display 6 and when the game player rotates the block 2 according to the hint and presses, for example, game operating section 7c each time, a certain character can be collected.

### 3. Mystery Game

When the block 2 is rotated and a face of a design block 2 is moved to the left of the display 6 of the game machine block 2a and for example, the game operating section 7c is pressed, it is assumed the place marked on the face is visited. A puzzle is solved at each place to solve the mystery. As the game progresses, for example, a game advancing instruction such as “Take a train to the theme park and gather evidence.” with a time limit is displayed on the display 6. In this case, the face of the design block 2 (face marked with “train”) is moved to the left of the display 6 of the game machine block 2a and for example, the game operating section 7c is pressed, and then the face of the design block 2 (face marked with “theme park”) is moved to the left of the display 6 of the game machine block 2a and for example, the game operating section 7c is pressed and evidence is searched for from items displayed on the display 6 according to the game advancing program. When the game player exceeds the time limit, for example, the game is over. Also, game advancing instruction such as “Follow in order the path the thief went.” is displayed on the display 6. In this case, the block 2 is rotated and for example, the game operating section 7c is pressed each time.

### 4. Other Games

The present invention can be applied to a character developing game. For example, the character can select department store or convenience store and buy goods sold there and pay money. The character can improve itself by selecting studio A, B, C, vocal school, etc. and performing the menu there. The character can choose a train, automobile or bicycle to use as a means of transportation to go to a place of destination.

### (Modification of the Present Invention)

An embodiment of the present invention is described above, however, the present invention is not limited to such embodiment and various modifications can be made within the scope of the spirit of the invention.

For example, in the above described embodiment, the identification information of one block 2 which is adjacent to the game machine block 2a is detected and the detected result is reflected in the game, however, identification information (ID) of a plurality of blocks among the blocks 2 which compose a same plane as the display 6 of the game machine block 2a (for example, blocks in a horizontal row) or identification information (ID) of all of the blocks can be detected.

A specific embodiment of this case is, for example, the necessary identification information can be easily detected by performing token ring method of communication centering around the game machine block 2a. An example of the token ring method or other method which can be used is described in, for example, Japanese Patent No. 3765755.

With this structure, the game procedure can be changed when for example, all of the blocks 2 composing the same plane as the display 6 are the same color, etc. Also, the alignment sequence of the block 2 can be detected, and therefore a game which varies widely can be enjoyed.

Incidentally, in a case where the game procedure is changed when for example, all of the blocks 2 composing the same plane as the display 6 are the same color, the input and output electric terminal and the wiring connected to the input electric terminal and the output electric terminal are provided on each of the detected blocks 2 to be structured so that all of the blocks 2 composing the same plane as the display 6 are electrically connected only when all of the blocks 2 composing the same plane as the display 6 are the same color, and the game machine block 2a detects this. In this case, when the color which is the same is also detected, the pattern of the electric terminal and wiring can be changed according to color.

Also, in the above described embodiment, the portable electronic game machine structured with two blocks each in vertical and horizontal directions on each plane is described, however, a portable electronic game machine structured with the same number of blocks in vertical and horizontal directions on each plane can be used. As an example of a structure of a cubic logic toy, there is known a technique described in Japanese Unexamined Patent Application Publication No. 2007-509640 and by applying the present invention to this technique, a portable electronic game machine composed with the same number of blocks, which is three blocks or more each in vertical and horizontal directions on each plane can be achieved.

However, including the above described embodiment, it is preferable that the number of blocks aligned in vertical and horizontal directions on each plane is three blocks or less on each plane. If the number of blocks is four or more, there is a design block which is not adjacent to the game machine block even if the block is rotated.

Incidentally, to explain an example of a connecting structure in a block where the number of blocks is three each in vertical and horizontal directions on each plane, the retaining piece 12 shown in FIG. 4 is rotatably structured to attach one block each to each retaining piece 12 as well as involving one block supporting member 8 each between adjacent block supporting members 8 shown in FIG. 4 and one block is attached to each of the block supporting members 8 in between.

In the portable electronic game machine structured with the same number of blocks which is three or more blocks each in vertical and horizontal directions on each plane, it is preferable that the block positioned in the middle of the nine blocks composing a plane is the game machine block, however, the middle block among three blocks composing one edge can be the game machine block. This is because when the block positioned in the corner is the game machine block, a block which is not moved next to the game machine block is included among all of the design blocks.

Also, in the above described embodiment, a case where the basic configuration of the portable electronic game machine is a cube shape is described, however the basic configuration can be a ball shape, etc.

According to an aspect of the preferred embodiments, there is provided a portable electronic game machine including:

a chassis which can be in a basic configuration where each of a front plane, left plane, right plane, flat plane, bottom plane and rear plane is composed of a same number of blocks in vertical and horizontal directions and the chassis can change its configuration by rotating the block around three axis lines which are orthogonal to each other and which pass through the center of the plane, wherein

each block group provided aligned along each of the three axis lines is structured to be able to rotate around the axis line independently with respect to other block groups;

part of the blocks is structured as a game machine block;

at least part of the remaining blocks is structured as an information holding block to hold identification information;

the game machine block includes:
a game section to advance a game;
a display section to display an image of a game advanced by the game section; and
an identification information detecting section which can detect the identification information when the information holding block and the game machine block are in a predetermined position relation; and

the game section is structured to advance the game by reflecting a detected result by the identification information detecting section.

Preferably, in portable electronic game machine, each of the planes is structured with two or three of the blocks in vertical and horizontal directions.

Preferably, in the portable electronic game machine,

the information holding block holds the identification information in a facing portion facing each other a predetermined portion of the game machine block when the information holding block is adjacent to the game machine block in a predetermined direction; and

the identification information detecting section can detect the identification information when the information holding block is adjacent to the game machine block in a predetermined direction.

Preferably, in the portable electronic game machine, the identification information is held in each of the facing portions in the information holding block and the pieces of identification information are different from each other.

Consequently, the direction the information holding block faces also influences the game procedure, and thus a more complicated game can be enjoyed.

Preferably, in the portable electronic game machine,

a design is marked on the outer face of the information holding block; and

the game section advances the game reflecting the design as the game reflecting the detected result by the identification information detecting section.

Consequently, the design aligned on the same side as the outer face provided with the display section is reflected on the game which advances. Therefore, for example, the player can control the game to some extent by using the design.

Preferably, in the portable electronic game machine, the outer face of the game machine block is provided with an operating section to determine detecting timing by the identification information detecting section.

Consequently, the detecting by the identification information detecting section can be performed at a suitable timing, therefore, detecting the identification information of other information holding blocks by mistake during the rotation of the block can be prevented.

Preferably, in the portable electronic game machine, the game machine block is detachable.

Consequently, by replacing only the game machine block, a game with a different content can be enjoyed and also repair is easy.

Preferably, in the portable electronic game machine, the design is formed on an adhesive sheet.

Consequently, by changing the adhesive tape, the design marked on each outer face (exposed face) of the block can be changed with the replacement of the game machine block.

Preferably, in the portable electronic game machine, the game advanced by the game section is a game which changes the game procedure according to the detected order of the identification information detected by the identification information detecting section.

Consequently, a plurality of block operations while thinking of the order is necessary. Therefore, interest is enhanced.

According to the above described aspects, by rotating the block group, changing the external appearance of the game machine itself can be enjoyed, and also in the game procedure, the external appearance of the game machine itself needs to be changed while thinking, and this realizes a highly interesting portable electronic game machine.

The entire disclosure of Japanese Patent Application No. 2008-149023 filed on Jun. 6, 2008 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A portable electronic game machine comprising:
a chassis which can be in a basic configuration where each of a front plane, left plane, right plane, flat plane, bottom plane and rear plane is composed of a same number of blocks in vertical and horizontal directions and the chassis can change its configuration by rotating the block around three axis lines which are orthogonal to each other and which pass through the center of the plane, wherein
each block group provided aligned along each of the three axis lines is structured to be able to rotate around the axis line independently with respect to other block groups;
part of the blocks is structured as a game machine block;
at least part of the remaining blocks is structured as an information holding block to hold identification information;
the game machine block includes:
a game section to advance a game;
a display section to display an image of a game advanced by the game section; and
an identification information detecting section which can detect the identification information when the information holding block and the game machine block are in a predetermined position relation; and
the game section is structured to advance the game by reflecting a detected result by the identification information detecting section.

2. The portable electronic game machine according to claim 1, wherein each of the planes is structured with two or three of the blocks in vertical and horizontal directions.

3. The portable electronic game machine according to claim 1, wherein,
the information holding block holds the identification information in a facing portion facing each other a predetermined portion of the game machine block when the information holding block is adjacent to the game machine block in a predetermined direction; and
the identification information detecting section can detect the identification information when the information holding block is adjacent to the game machine block in a predetermined direction.

4. The portable electronic game machine according to claim 1, wherein the identification information is held in each of the facing portions in the information holding block and the pieces of identification information are different from each other.

5. The portable electronic game machine according to claim 4, wherein
a design is marked on the outer face of the information holding block; and
the game section advances the game reflecting the design as the game reflecting the detected result by the identification information detecting section.

6. The portable electronic game machine according to claim 1, wherein the outer face of the game machine block is provided with an operating section to determine detecting timing by the identification information detecting section.

7. The portable electronic game machine according to claim 1, wherein the game machine block is detachable.

8. The portable electronic game machine according to claim 1, wherein the design is formed on an adhesive sheet.

9. The portable electronic game machine according to claim 1, wherein the game advanced by the game section is a game which changes the game procedure according to the detected order of the identification information detected by the identification information detecting section.
